(19) United States
(12) Patent Application Publication
(10) Pub. No.: US 2004/0257002 A1
(43) Pub. Date: Dec. 23, 2004

(54) Socket capacitance for discharge lamps

(76) Inventors: Nicolas Hubertina Gerardus, Reijnders (NL); Cong Khanh Pham, Eindhoven (NL); Hendrik Anton Van Esveld, Eindhoven (NL)

Correspondence Address: Philips Electronics North America Corporation, Corporate Patent Counsel, PO Box 3001, Briarcliff Manor, NY, 10510, US

(21) Appl. No.: 10/493,172

(22) PCT Filed: Oct. 21, 2002
(86) PCT No.: PCT/IB02/04374

(30) Foreign Application Priority Data
Oct. 25, 2001 (EP) 012040846

(51) Int. Cl. H05B 37/02

(52) U.S. Cl. 315/209 CD; 315/312

(57) ABSTRACT

A method and a device for igniting two series-connected HID lamps (1A, 1B) are described, the two HID lamps being connected in series to a single ignitor (10). The ignitor generates a high voltage ignition pulse, which is sequentially applied to the two lamps sequentially, due to a capacitive unbalance between the two lamps. In order to ensure such capacitive unbalance, a capacitor (13) may be arranged in parallel with one of the lamps (1B).

The present invention relates in general to the art of discharge lamps, and more particularly to the art of HID lamps. Such lamps comprise a light-transmitting vessel enclosing a discharge space in a gastight manner, an ionizable filling and a pair of electrodes in the discharge space, each electrode being connected to a current conductor extending from the discharge space through the lamp vessel to the exterior. Starting such a lamp must be performed by applying a sufficiently high voltage across the electrodes, such that a discharge is caused which generates an initial plasma and an initial current, which eventually can grow to the operating current. Since HID lamps are commonly known to persons skilled in the art, it is not necessary to discuss their construction and operation here in more detail.

For operating a HID lamp, a power and control unit is necessary, indicated as “electronic ballast”. Such a ballast has an output for connection to a HID lamp, and is designed to generate at its output the voltages and currents necessary for operating such HID lamp connected to its output. Normally, for each lamp, one ballast is necessary. Since ballasts are rather bulky and relatively expensive, it would be favorable to operate more than one HID lamp by one electronic ballast.

During steady state operation of a HID lamp, the ballast should be capable of generating a certain current in the lamp, while a certain lamp voltage develops across the lamp electrodes. Thus, the ballast should be capable of generating such a steady state lamp current at a certain output voltage. The ballast will have been designed for a certain type of lamp, so it is known in advance what operative steady state lamp voltage to expect. Generally, the ballast will have been designed for a certain maximum output voltage, which will be somewhat higher than the nominal lamp voltage expected. If two lamps were series-connected to the ballast output, the voltage developing across this series connection would be the sum of the lamp voltages, i.e. twice the nominal lamp voltage expected for one lamp, which will be higher than the maximum output voltage of the ballast.

In principle, it would be relatively easy to design an electronic ballast for a higher steady state output voltage in order to allow two HID lamps to be connected in series.

The above applies to the steady state situation. However, for starting a HID lamp, high voltage ignition pulses are necessary, typically having a magnitude of 5 kV, and sometimes even as high as 20 kV. Upsizing a ballast to allow the operation of two HID lamps in series, taking the same approach as indicated above, would mean doubling the ignition pulse voltage. This, however, would involve a totally different ballast design because of the very high voltages to be handled. Furthermore, the ballast would then only be capable of operating two HID lamps in series, because if only a single HID lamp were connected to this upsized ballast it would receive ignition pulses which are too high, and lamp breakage would be very likely.

Furthermore, mechanical components for mounting the lamps, such as fittings, and the lamp construction itself (single ended) are typically designed for a certain maximum voltage, usually 5 kV. If it is intended to use voltages above 5 kV, it is necessary to adapt those components and/or the lamp construction and make them suitable for such higher voltages, but also regulations require a timer function inside the ballast.

Thus, it is desirable not to exceed 5 kV.

The present invention aims to solve this problem. More particularly, the present invention aims to provide a method and a device for operating two HID lamps in series without increasing the ignition pulse voltage.

As is known to persons skilled in the art, an electronic ballast, in order to generate an ignition pulse for a HID lamp, builds up electrical energy which, simply stated, is used to generate a high voltage pulse. The present invention is based inter alia on the insight that, when the high voltage ignition pulse causes a discharge in the lamp, the discharge consumes only relatively little energy from the starting pulse. This means that, in principle, enough energy remains in the starting pulse for igniting a second lamp. Based on this recognition, the present invention proposes to ignite two HID lamps sequentially, one after the other, using the same high voltage pulse. Thus, according to the present invention, a high voltage ignition pulse is applied to a first HID lamp, until discharge, and then the same high voltage ignition pulse is applied to a second HID lamp connected in series with the first one. Because the ignition pulse is applied to both lamps sequentially, the magnitude of the high voltage ignition pulse only needs to be designed for igniting one lamp, i.e. does not have to be increased with respect to the magnitude of ignition pulses generated by standard types of electronic ballasts intended for only one lamp.

In order to ensure sequential breakdown in two HID lamps connected in series, the invention proposes a capacitive unbalance between the two lamps. In one embodiment, a capacitor is connected in parallel with one of said lamps. After ignition of the first lamp, the capacitor may be disconnected, but this is not necessary.

The above-mentioned and other aspects, features and advantages of the present invention will be explained in more detail by the following description of preferred embodiments with reference to the drawings, in which same reference numerals indicate the same or similar components, and in which:

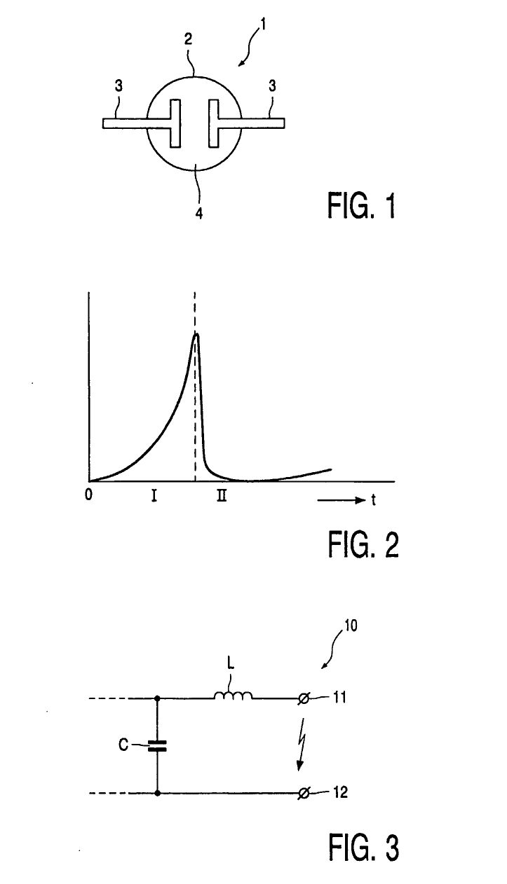

FIG. 1 schematically illustrates a HID lamp;

FIG. 2 illustrates the electrical behavior of a HID lamp;

FIG. 3 illustrates some components of an electronic ballast;

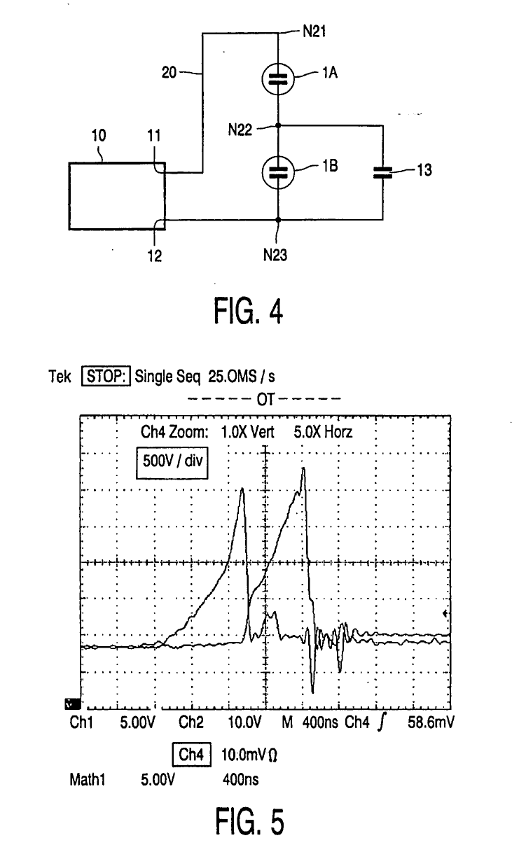

FIG. 4 schematically illustrates the present invention in general;

FIG. 5 shows results of a voltage measurement performed on two lamps connected in series;

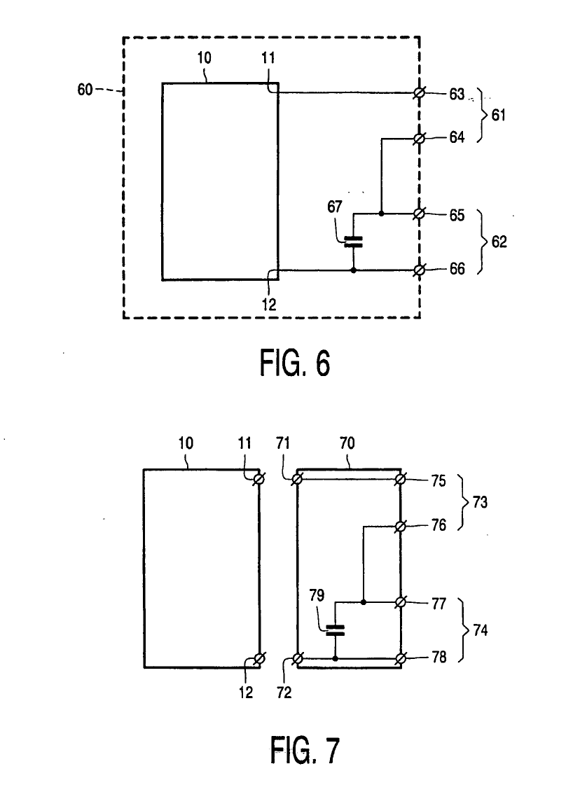

FIGS. 6 and 7 schematically show the present invention implemented in a ballast device;

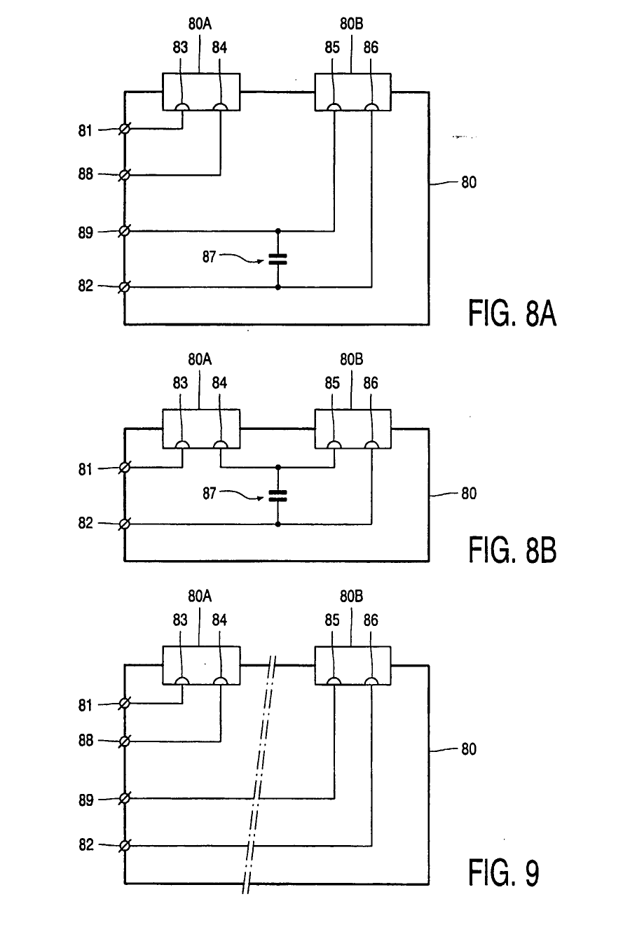

FIGS. 8A, 8B and 9 schematically show the present invention implemented in a lamp housing;

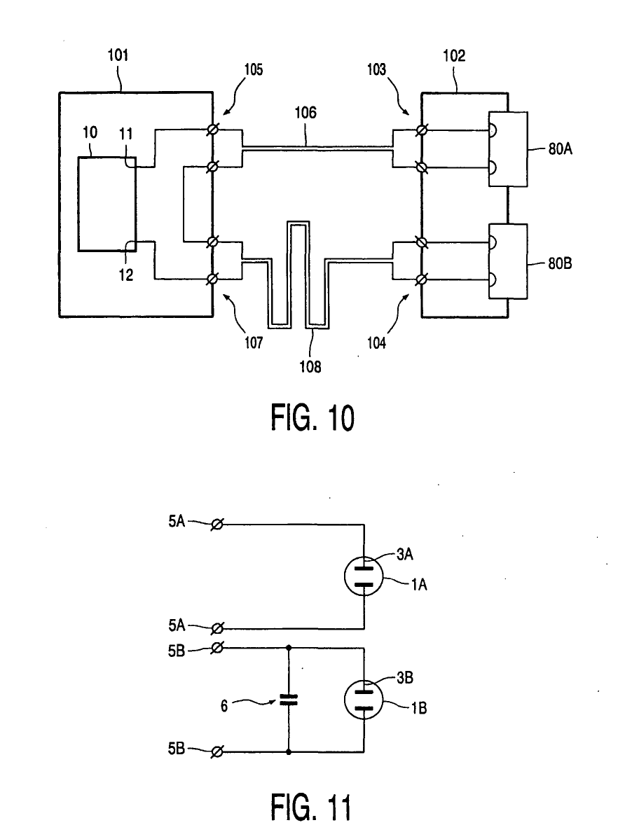

FIG. 10 schematically illustrates a further embodiment of the present invention; and

FIG. 11 schematically illustrates yet a further embodiment of the present invention.

FIG. 1 schematically shows a HID lamp 1, comprising a closed balloon 2 and two electrodes 3 extending through the balloon 2. The balloon 2 is filled with a gas 4. The free ends of the electrodes 3 are arranged at a relatively short distance with respect to each other, typically in the order of a few millimeters in the case of metal halide lamps and a few centimeters in the case of high pressure sodium lamps.

FIG. 2 is a timing diagram illustrating some aspects of the electrical behavior of a HID lamp. The horizontal axis represents time t; the vertical axis represents voltage. Before time t=0, the lamp is off. At time t=0, the lamp is switched on. Now, four operating phases can be distinguished. In the first phase I, a high voltage is applied to the electrodes 3. Typically, this high voltage is in the order of 5 kV. Typically, this voltage is applied in the form of a pulse, having a certain rise time, as illustrated in FIG. 2, which typically is in the order of 0.1-0.5 μs. At a certain moment, the lamp 1 breaks down, i.e. a discharge occurs between the electrodes 3 as a consequence of the high voltage applied to the electrode 3. This moment represents the transition from phase I to phase II. Due to this discharge, the voltage across the electrodes 3 decreases rapidly. However, there is not yet a true conductive path between the electrodes 3 so the current through the lamp 1 is relatively low. This second phase II is also referred to as take over phase (‘take over’ of the lamp current from the ignitor to the ballast by means of the open circuit voltage).

In a third phase, a glow discharge develops between the electrodes 3, causing an increase in conductivity and hence an increase in current magnitude. In a fourth phase, an arc is burning between the electrodes 3 at a relatively high current; in this phase, the nominal lamp voltage is in the order of about 100 V.

The duration of the four phases is not shown to scale in FIG. 2. Typically, the glow phase has a duration in the order of about one second. Furthermore, in the fourth phase or arc phase, it typically takes some thirty seconds or more for the lamp to stabilize and reach the steady state.

FIG. 3 illustrates some important components of a typical power and control unit or electronic ballast 10 for driving a HID lamp 1. Since such drivers are known per se, no full circuit diagram is shown. For generating the high voltage ignition pulse, the electronic ballast 10 typically comprises a capacitor, a switch and a pulse transformer, and also control components which are not shown in FIG. 3. FIG. 3 shows that the ballast 10 has output terminals 11, 12, a main inductor L having one end connected to a first output terminal 11, a main capacitor C having one electrode connected to the second output terminal 12 and its other electrode connected to a second terminal of the inductor L. Basically, the ignition pulse is generated by this LC combination, while the energy capabilities of the ballast 10 depend strongly on the capacitive value of this main capacitor C.

While the lamp 1 is in the steady state, the ballast 10 should serve as a current source, feeding the lamp 1 with a current the magnitude of which is designed to fit a certain specific lamp, while the voltage developing across the output terminals 11, 12 is determined by the ohmic resistance of the lamp during the steady state. With two lamps in series, the currents to be delivered can remain the same, but the ballast 10 should be capable of handling an output voltage twice as high. Adapting the design of any ballast to meet this requirement should be relatively easy to a person skilled in the art. However, the present invention does not specifically relate to the steady state behavior of the ballast; in fact, the present invention relates to the ignition phase of the lamp behavior, i.e. the first phase I in FIG. 2. In the ignition phase, there is no current through the lamp until breakdown. During this phase, the ballast 10 should serve as a voltage source, the voltage primarily being provided from the main capacitor C.

If two lamps are connected in series to the output terminals 11, 12 of the ballast 10, the voltage pulse, which is designed for igniting only one lamp, normally will not succeed in igniting the two series-connected lamps reliably.

FIG. 4 shows schematically the solution proposed by the present invention. Two lamps 1A and 1B are connected in series to the output terminals 11 and 12 of the ballast 10. An auxiliary capacitor 13 is connected in parallel with the second lamp 1B.

In the arrangement of FIG. 4, the operation is as follows.

When the ballast 10 generates its ignition pulse at its output, the capacitor 13 acts as a short circuit bypassing the second lamp 1B, so the full pulse is applied to the first lamp 1A. As a result, the first lamp 1A breaks down, and the first lamp 1A ignites. As a consequence, the voltage developed across the first lamp 1A drops to a few hundred volts, causing practically the full output pulse of the ballast 10 to be applied across the second lamp 1B now. FIG. 5 shows the results of a measurement performed in an actual situation. The first voltage pulse is measured across the first lamp 1A, while the second voltage pulse is measured across the second lamp 1B. An important aspect in this respect is that both voltage pulses across said two lamps are generated by one and the same output pulse of the ballast 10.

Although the exact capacitance value of the auxiliary capacitor 13 connected in parallel with the second lamp 1B is not crucial, there are some considerations to be taken into account. In order to provide an adequate short circuit for the voltage pulse, the capacitive value C13 of auxiliary capacitor 13 should have a minimum value, preferably in the order of at least twice the capacitance of the lamp itself, i.e. at least about 20 pF. However, as soon as the first lamp 1A has been ignited, the remainder of the voltage pulse, minus the voltage drop across the first lamp 1A, is now applied across the parallel connection of second lamp 1B and auxiliary capacitor 13. This parallel connection defines a capacitive load for the ballast 10, which should not be too high in relation to the main capacitor C in the output stage of the ballast 10. This requirement defines an upper limit for the capacitive value of the auxiliary capacitor 13. In general, the capacitive value of the auxiliary capacitor 13 should not be more than about 100 pF-1 nF (depending on the maximum capacitance the ignitor can handle).

In the above, the invention has been explained with reference to a separate auxiliary capacitor 13 connected in parallel with the second lamp 1B. However, in principle it is not necessary to actually have a distinct capacitor 13. In principle, the important feature is that, in the external current loop 20 between the two output terminals 11 and 12 of the ballast 10, there is a capacitive unbalance between the two lamps 1A and 1B. In FIG. 4, three nodes in the current loop 20 are indicated as N21, N22, and N23, respectively. The first lamp 1A is connected between the first two nodes N21 and N22, whereas the second lamp 1B is connected between the second and third nodes N22 and N23. In the circuit 20, the capacitive value C1 between the first and second nodes N21 and N22 differs from the capacitive value C2 between the second and third nodes N22 and N23. The fact that the capacitive value C1 between the first and second nodes N21 and N22 is smaller than the capacitive value C2 between the second and third nodes N22 and N23 has the effect that, if a high frequency signal such as a high voltage pulse, is applied across the first and second nodes N21 and N22, the largest voltage drop occurs across the first capacitance C1.

This capacitive ratio C2/C1 can be implemented in many ways within the scope of the present invention. As discussed in the above and as illustrated in FIG. 4, a separate auxiliary capacitor 13 can be mounted in parallel with the second lamp 1B. This solution can be implemented in various ways, as illustrated in FIG. 6 and subsequent Figures.

FIG. 6 schematically shows a ballast device 60, comprising a standard electronic ballast 10, possibly adapted to allow a larger-than-customary steady state output voltage and having first and second output terminals 11 and 12, respectively. The ballast device 60 is designed to drive two lamps, and for this purpose the ballast device 60 has two outputs 61 and 62. The first output 61 consists of two output terminals 63, 64, the first output terminal 63 being connected to the first output terminal 11 of the standard ballast 10. Likewise, the second output 62 consists of third and fourth output terminal 65 and 66, the fourth output terminal 66 being connected to the second output terminal 12 of the standard ballast 10. The second output terminal 64 and the third output terminal 65 are electrically connected to each other. As an alternative, instead of having two separate output terminals 64 and 65, a single common output terminal may be provided. Furthermore, the ballast device 60 comprises a capacitor 67 connected between the third and fourth output terminals 65 and 66. For use, a first lamp may be connected in a conventional manner to the first output 61, and a second lamp may be connected in a conventional manner to the second output 62.

A second implementation of the present invention is illustrated in FIG. 7. A standard ballast again referenced 10 is shown, having first and second output terminals 11, 12. A doubling module 70 has two input terminals 71 and 72, a first output 73 with two output terminals 75 and 76, and a second output 74 with two output terminals 77 and 78. The first output terminal 75 is connected to the first input terminal 71, the fourth output terminal 78 is connected to the second input terminal 72, and the second and third output terminals are connected to each other. Again, the second and third output terminals 76 and 77 may be combined into one common output terminal. A capacitor 79 is connected between the third output terminal 77 and the fourth output terminal 78.

This module can be used to adapt a standard ballast 10 for use with two lamps in series. The input terminals 71 and 72 of the doubling module 70 are connected to the original output terminals 11 and 12 of the ballast 10, and two lamps can be connected to the outputs 73 and 74 of the module 70.

In practice, a HID lamp will be mounted in a socket, which is part of a lamp housing. Such lamp housing may also contain the ballast; alternatively, the lamp housing may be separate, which is suitable for connection to a ballast. The present invention may also be implemented in such a housing, as will be explained below.

FIG. 8A shows a lamp housing 80 comprising two lamp sockets 80A and 80B for receiving, respectively, lamps 1A and 1B. The housing 80 has two terminals 81, 82, for connection to the output terminals 11, 12, respectively, of a standard ballast 10. The first lamp socket 80A has two socket terminals 83, 84, which connect to the lamp electrodes when a lamp is mounted in the first socket 80A. Similarly, the second lamp socket 80B has socket terminals 85, 86. The first socket terminal 83 of the first socket 80A is connected to the first input terminal 81 of the housing 80, whereas the second socket terminal 86 of the second socket 80B is connected to the second input terminal 82 of the housing 80. The second socket terminal 84 of the first socket 80A is connected to the first socket terminal 85 of the second socket 80B. A capacitor 87 is connected to the socket terminals 85 and 86 of the second socket 80B.

FIG. 8B illustrates a modification of the housing 80. Like reference numerals refer to like or similar parts. In this modification, the housing 80 has four input terminals 81, 88, 89, 82. The second socket terminal 84 of the first socket 80A is now connected to the second input terminal 88 in stead of to the first socket terminal 85 of the second socket 80B, which in turn is now connected to the third input terminal 89. These four input terminals of the modified housing 80 may be connected to a ballast device as illustrated in FIG. 6, in which the capacitor 67 has been omitted.

As mentioned earlier, it is not necessary to implement the capacitive difference by incorporating a distinct separate capacitor in a ballast or in a housing. The capacitive unbalance can also be created by different wiring. FIG. 9 illustrates a housing 80, similar to the housing 80 of FIG. 8B with the exception that the capacitor 87 has been omitted. In this case, also, the housing 80 is intended for connection to a ballast device 60 as illustrated in FIG. 6, with the exception that the capacitor 67 has been omitted, so that the outputs 61 and 62 are symmetrical as regards capacitance. In the case of the housing 80 illustrated in FIG. 9, the conductive path between input terminals 81 and 88 on the one hand and socket terminals 83, 84 on the other hand is significantly shorter than the conductive path between input terminals 89 and 82 on the one hand and socket terminals 85, 86 on the other hand. This difference in length may be achieved by some excess wiring length or simply by the fact that the housing 80 is an elongated housing in which the first socket 80A is located relatively close to the input side and the second lamp socket 80B is located relatively far away from the input side.

FIG. 10 illustrates a situation where the capacitive unbalance is also achieved by a difference in wiring lengths instead of a separate capacitor. In this case, a symmetrical ballast device 101, comparable to the ballast device 60 of FIG. 6 but without the capacitor 67, is connected to a symmetrical housing 102 having two lamp sockets 80A and 80B. The first lamp socket 80A is connected to a first input 103, while the second lamp socket 80B is connected to a second input 104, the wiring between input 103 and first lamp socket 80A on the one hand and the wiring between second input 104 and second lamp socket 80B on the other hand being symmetrical. The first input 103 of the housing 102 is connected to a first input 105 of the ballast device 101 through first wiring 106, whereas the second input 104 of the lamp housing 102 is connected to a second output 107 of the ballast device 101 through second wiring 108. As is clearly shown schematically in FIG. 10, the length of the second wiring 108 is larger than the length of the first wiring 106, thus creating a difference in capacitive value, as measured at the outputs 105 and 107 of the ballast device 101, or as measured at the lamp sockets 80A and 80B.

Thus, the capacitive unbalance may be effected by differences in wiring, i.e. that a first wiring has a capacitive value differing from the capacitive value of a second wiring. Using the same type of wiring, this can for instance be achieved if the length of the first wiring differs from the length of the second wiring. However, it is also possible to use different types of wiring having a different intrinsic capacity (expressed as capacity per unit length), in which case the wiring lengths may even be equal.

It is, however, also possible to implement the present invention in the HID lamps themselves. FIG. 11 illustrates a combination of two HID lamps 1A and 1B, each lamp having lamp electrodes 3A and 3B, respectively, and each lamp having lamp terminals 5A and 5B, respectively. The lamps are intended to be driven by a symmetrical ballast device 101 such as illustrated in FIG. 10, or the ballast device 60 as illustrated in FIG. 6 but without the capacitor 67, such lamps being connected to the ballast either directly or through a symmetrical lamp housing such as the lamp housing 102 as illustrated in FIG. 10. In this case, the capacitive unbalance is effected by the two lamps 1A and 1B having different capacitive values between their lamp terminals 5A and 5B, respectively.

In a possible embodiment, the second lamp 1B has a capacitor 6 built in, which is connected between its two lamp terminals 5B. However, it is also possible that the capacitive value of second lamp 1B differs from the capacitive value of first lamp 1A due to a different design, such as for instance a different size of the electrodes 3B or a different distance between the electrodes 3B, or both.

It should be clear to a person skilled in the art that the present invention is not limited to the embodiment discussed above, but that several amendments and modifications are possible without departing from the scope of the invention as defined in the appending claims. For instance, the principle proposed by the present invention is also applicable to TL lamps, PL lamps and other types of gas discharge lamps with preheating filaments as electrodes.

Furthermore, although in the above the invention is explained in the context of ignition by means of ignition pulses, the present invention is also applicable in the case of resonant ignition. Thus, the phrase “ignition pulse” as used in the claims should be interpreted as also covering resonant voltages.

Furthermore, although in the above the invention is explained in the context of an electronic ballast, the present invention is also applicable in a case of a magnetic ballast. Thus, the phrase “ballast” as used in the claims should be interpreted as covering an electronic ballast as well as a magnetic ballast.

1. System for feeding two gas discharge lamps, the system comprising:
a ballast;
a first lamp socket connected to an output of the ballast;
a second lamp socket connected to an output of the ballast;
a series connection between the two lamp sockets;
wherein a capacitive value as measured on the socket terminals of the first lamp socket differs from a capacitive value as measured on the socket terminals of the second lamp socket.

2. System according to claim 1, comprising a first wiring connecting the first lamp socket to the ballast, and a second wiring connecting the second lamp socket to the ballast, wherein the first wiring has a capacitive value differing from the capacitive value of the second wiring.

3. System according to claim 2, wherein the length of the first wiring differs from the length of the second wiring, wherein the first wiring has an intrinsic capacity differing from the intrinsic capacity of the second wiring.

4. A system according to claim 1 having a driver device for driving two gas discharge lamps, comprising:
a ballast having a first output terminal and a second output terminal;
a first output for connection to a first lamp, the first output having a first output terminal connected to the first output terminal of the ballast;
a second output having a fourth output terminal connected to the second output terminal of the ballast;
the first output having a second output terminal, and the second output having a third output terminal connected to the second output terminal of the first output;
the driver device further comprising a capacitance connected between the output terminals of one of said outputs.

5. Driver device according to claim 4, wherein the second and third output terminals are implemented as one common terminal.

6. Lamp housing comprising two lamp sockets for receiving gas discharge lamps, the first lamp socket having first and second socket terminals, and the second lamp socket having third and fourth socket terminals;
wherein the capacitive value as measured between the first and second socket terminals differs from the capacitive value as measured between the third and fourth socket terminals.

7. Lamp housing according to claim 6, comprising a capacitance connected between the third and fourth socket terminals of the second lamp socket.

8. Lamp housing according to claim 7, comprising:
a first input terminal connected to the first socket terminal;
a second input terminal connected to the fourth socket terminal of the second lamp socket;
wherein the second socket terminal of the first lamp socket is connected to the third socket terminal of the second lamp socket.

9. Lamp housing according to claim 7, comprising:
a first input terminal connected to the first socket terminal;
a second input terminal connected to the fourth socket terminal of the second lamp socket;
a third input terminal connected to the second socket terminal of the first lamp socket;
a fourth input terminal connected to the third socket terminal of the second lamp socket;
wherein the first and third input terminals define a first input associated with the first lamp socket and wherein the second and fourth input terminals define a second input associated with the second lamp socket.

10. Lamp housing according to claim 6, comprising:
a first input terminal connected to the first socket terminal;
a second input terminal connected to the fourth socket terminal of the second lamp socket;
a third input terminal connected to the second socket terminal of the first lamp socket;
a fourth input terminal connected to the third socket terminal of the second lamp socket;
a first input terminal connected to the first socket terminal;
a second input terminal connected to the fourth socket terminal of the second lamp socket;
wherein the length of the wiring between first input and first lamp socket differs from the length of the wiring between second input and second lamp socket.
